(19) United States
(12) Patent Application Publication
(10) Pub. No.: US 2015/0006209 A1
(43) Pub. Date: Jan. 1, 2015

(54) METHOD AND SYSTEM FOR BUILDING EVENT BASED TRAVEL

(71) Applicant: Amadeus S.A.S., Biot (FR)

(72) Inventors: Javier Busquiel, Waltham, MA (US); Alexandra Candelas, Arlington, MA (US); Simon Cierniak, Belmont, MA (US); Co Dam, Malden, MA (US); Deepak Kochar, Acton, MA (US); Tadhg Pearson, Boston, MA (US); Kamil Rybczyk, Watertown, MA (US); Alejandro Sanchez, Woburn, MA (US); John Scarff, Quincy, MA (US); Mahenthiran Venugopal, Arlington, MA (US)

(21) Appl. No.: 14/491,239

(22) Filed: Sep. 19, 2014

Related U.S. Application Data
(60) Provisional application No. 61/880,160, filed on Sep. 19, 2013.
(60) Provisional application No. 61/880,791, filed on Sep. 20, 2013.

(51) Int. Cl. G06Q 10/02; G06F 17/30

(52) U.S. Cl. CPC G06Q 10/02; G06F 17/30241; G06F 17/30864
USPC 705/5

(57) ABSTRACT

Methods, apparatuses, and computer program products for building a travel plan for an event. Departure location and preference information associated with one or more users of a media platform is received from a social media platform. The preference information may be further associated with one or more event hosts. Future event information for at least one of the event hosts is then accessed. The future event information is provided to the one or more users of the media platform. Initial travel pricing information for an initial travel option is accessed by the one or more users from the departure location to at least one of the future events from one or more travel databases. The initial travel pricing information for at least the initial travel option to the future events is then provided to the one or more users of the media platform.

### CROSS-REFERENCE TO RELATED APPLICATIONS

The present application claims the benefit of U.S. Provisional Application Ser. No. 61/880,160, filed Sep. 19, 2013, and U.S. Provisional Application Ser. No. 61/880,791, filed Sep. 20, 2013, the disclosure of each which is hereby incorporated herein by reference in their entireties.

### BACKGROUND

The invention generally relates to computers and computer software, and in particular to methods, systems, and computer program products for travel planning

The Internet is a publically accessible global network that carries data through packet switching using the Internet Protocol (IP). A computer connected to the Internet can send and receive data from other computers that are also connected to the Internet, thereby allowing the computers to exchange information and provide services to each other, such as electronic mail, online chat, file transfer and web browsing. One way users access the Internet is by using a web browser, which is an application that facilitates retrieving and displaying information provided by web sites using standard communication protocols.

Due to the popularity and convenience of accessing information through the Internet, many travel providers now offer travel services that may be purchased through a web site. Internet users may thereby book trips using websites which provide travel booking services on the Internet. Although purchasing travel services using the Internet has proven both popular and convenient, these systems still have shortcomings. Thus, improved systems, methods, and computer program products are needed that improve the user experience in purchasing and planning trips using the Internet.

### SUMMARY

In an embodiment of the invention, a method of building a travel plan for an event is provided. The method includes accessing a departure location and preference information associated with one or more users of a media platform, associating the preference information of the one or more users with one or more event hosts, and accessing future event information for at least one of the one or more event hosts. The method further includes providing the future event information to the one or more users of the media platform, accessing initial travel pricing information for an initial travel option by the one or more users from the departure location to at least one of the future events from one or more travel databases, and providing the initial travel pricing information for at least the initial travel option to the future events to the one or more users of the media platform.

In another embodiment of the invention, the method of building the travel plan for the event may further include receiving a selection of one of the future events by the one or more users of the media platform to define a selected future event, accessing additional travel pricing information, different than the initial travel pricing information, for additional travel options by the one or more users from the departure location to the selected future event from the one or more travel databases, and providing the additional travel pricing information to the one or more users of the media platform.

In another embodiment of the invention, the method of building the travel plan for the event may further include receiving a first booking request from a user for at least one travel option selected from a group of travel options consisting of the initial travel option to the selected future event and the additional travel options to the selected future event, and booking travel through one or more travel booking databases for the one or more users according to the at least one travel option selected from the group of travel options consisting of the initial travel option and the additional travel options to the selected future event.

In another embodiment of the invention, the method of building the travel plan for the event may further include accessing one or more attraction databases to identify attractions geographically near the selected future event as identified attractions, and providing attraction information associated with the identified attractions to the one or more users of the media platform.

In another embodiment of the invention, the method of building the travel plan for the event may further include receiving a second booking request from a user for one or more of the identified attractions, and booking attendance to the one or more of the identified attractions.

In another embodiment of the invention, the method of building the travel plan for the event may further include plotting a first geographic location of the selected future event on an event map, and plotting a second geographic location of the identified attractions on the event map.

In another embodiment of the invention, the method of building the travel plan for the event may further include providing a plurality of categories to the one or more users of the media platform, and receiving a selection of one of the plurality of categories as a selected category, wherein the future event information provided to the one or more users is associated with the selected category. These categories may include at least one category selected from a group consisting of a dining category, a nightlife category, a coffee shop category, a music category, a film category, an arts category, a theatre category, a sports participation category, and a sports for spectators category.

In an embodiment of the method of building a travel plan for the event, the future events and future event information may be associated with events that are transient in at least one of starting time and geographic location.

In another embodiment of the invention, an apparatus for building a travel plan for an event for auditing a transaction is provided. The apparatus includes a processor and memory. The memory includes program code that, when executed by the processor, causes the apparatus to access a departure location and preference information associated with one or more users of a media platform, associate the preference information of the one or more users with one or more event hosts, and access future event information for at least one of the one or more event hosts. The program code may further cause the apparatus to provide the future event information for future events to the one or more users of the media platform, access initial travel pricing information for an initial travel option by the one or more users from the departure location to at least one of the future events from one or more travel databases, and provide the initial travel pricing information for at least the initial travel option to the future events to the one or more users of the media platform.

In another embodiment of the invention, a computer program product for building a travel plan for an event is provided. The computer program product includes a non-transitory computer-readable storage medium, and program code stored on the non-transitory computer-readable storage medium. The program code may be configured, when executed by the processor, to cause the processor to access a departure location and preference information associated with one or more users of a media platform, associate the preference information of the one or more users with one or more event hosts, and access future event information for at least one of the one or more event hosts. The program code may further cause the processor to provide the future event information for future events to the one or more users of the media platform, access initial travel pricing information for an initial travel option by the one or more users from the departure location to at least one of the future events from one or more travel databases, and provide the initial travel pricing information for at least the initial travel option to the future events to the one or more users of the media platform.

In another embodiment of the invention, a method of defining a travel itinerary for each of a plurality of users of a social media platform for travel to a common destination is provided. The method may include presenting a plurality of travel themes across the media platform to at least one initial user of the media platform, receiving a travel theme selection from the at least one initial user of the media platform, and presenting a plurality of travel destinations to the plurality of users of the media platform, wherein the plurality of users are selected by the at least one initial user of the media platform. The method may further include accessing a departure location for each of the plurality of users from the social media platform, wherein the departure location of at least one of the plurality of users is different from another of the plurality of users. The method may then access the plurality of travel destinations associated with the travel theme selection and travel information from the departure location and to at least one of the plurality of travel destinations for each of the plurality of users from a travel database. The travel information may include travel availability information and travel pricing information. The method may further include presenting the travel information to the plurality of users through the media platform, receiving preference information from the plurality of users through the media platform, and calculating a selected destination based on preference information associated with the plurality of travel destinations.

In another embodiment of the invention, the method of defining the travel itinerary for each of the plurality of users of the social media platform for travel to the common destination may further include booking travel for at least one of the plurality of users through a travel booking database.

In another embodiment of the invention, presenting the travel information to the plurality of users through the media platform may include presenting travel information that provides a lowest deviation from a mean of travel pricing for each of the plurality of users.

In another embodiment of the invention, presenting the travel information to the plurality of users through the media platform may include presenting travel information that provides a lowest deviation from a mean of travel duration for each of the plurality of users.

In another embodiment of the invention, an apparatus for defining a travel itinerary for each of a plurality of users of a social media platform for travel to a common destination is presented. The apparatus includes a processor and memory. The memory includes program code that, when executed by the processor, causes the apparatus to present a plurality of travel themes across a media platform to at least one initial user of the media platform, receive a travel theme selection from the at least one initial user of the media platform, and present a plurality of travel destinations to a plurality of users of the media platform, wherein the plurality of users are selected by the at least one initial user of the media platform. The program code may further cause the apparatus to access a departure location for each of the plurality of users from a social media platform, wherein the departure location of at least one of the plurality of users is different from another of the plurality of users. The program code may further cause the apparatus to access the plurality of travel destinations associated with the travel theme selection, and travel information from the departure location and to at least one of the plurality of travel destinations for each of the plurality of users from a travel database, wherein the travel information includes travel availability information and travel pricing information. The program code may further cause the apparatus to present the travel information to the plurality of users through the media platform, receive, through the media platform, preference information from the plurality of users, and calculate a selected destination based on preference information associated with the plurality of travel destinations.

In another embodiment of the invention, a computer program product for building a travel plan for an event is provided. The computer program product includes a non-transitory computer-readable storage medium, and program code stored on the non-transitory computer-readable storage medium. The program code may be configured, when executed by the processor, to cause the processor to present a plurality of travel themes across a media platform to at least one initial user of the media platform, receive a travel theme selection from the at least one initial user of the media platform, and present a plurality of travel destinations to a plurality of users of the media platform, wherein the plurality of users are selected by the at least one initial user of the media platform. The program code may further cause the processor to access a departure location for each of the plurality of users from a social media platform, wherein the departure location of at least one of the plurality of users is different from another of the plurality of users. The program code may further cause the processor to access the plurality of travel destinations associated with the travel theme selection, and travel information from the departure location and to at least one of the plurality of travel destinations for each of the plurality of users from a travel database, wherein the travel information includes travel availability information and travel pricing information. The program code may further cause the processor to present the travel information to the plurality of users through the media platform, receive, through the media platform, preference information from the plurality of users, and calculate a selected destination based on preference information associated with the plurality of travel destinations.

### BRIEF DESCRIPTION OF THE FIGURES

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a Global Distribution System (GDS), a social networking system, a service provider system, a traveler system, and a travel agency system.

FIG. 2 is a diagrammatic view of an exemplary computer that may be used for implementing the systems of FIG. 1.

FIG. 3 shows a flow chart associated with building a travel plan through a media platform, according to one embodiment.

FIG. 4 is a depiction of a user interface that shows a variety of categories of events as tabs on one side of the user interface and graphical representations of user preferences in a central portion of the user interface, according to one embodiment.

FIG. 5 is a depiction of a user interface that shows a tab that is associated with a music category of events as being selected, graphical representations of event hosts associated with the music category of events and user preferences, and future event information for each event host, according to the embodiment of FIG. 4.

FIG. 6 shows a map of a selected future event and a pop out including future event information for the selected future event, according to the embodiment of FIG. 4.

FIG. 7 shows multiple travel options and associated travel pricing information for a user to attend the selected future event, according to the embodiment of FIG. 4.

FIG. 8 is a diagrammatic view of an initial screen for planning group travel displayed to a user by a social media platform.

FIG. 9 is a diagrammatic view of an exemplary screen for planning group travel including a pin and displayed subsequently to the screen in FIG. 8.

FIG. 10 is a diagrammatic view of an exemplary pop up screen that enables the user to publish a trip to a user profile on the social media platform.

FIG. 11 is a diagrammatic view of an exemplary pop up screen that enables the user to exchange messages with another user on the social media platform.

FIG. 12 is a diagrammatic view of an exemplary home page of a user profile of the social media platform.

FIG. 13 is a diagrammatic view of an exemplary trip page associated with the user profile of FIG. 12.

### DETAILED DESCRIPTION

Aspects of the present invention relate to providing future event information and associated travel information to a user of a media platform, such as social media platform that supports a virtual social network. Providing event and travel information may allow a user of the media platform (e.g., a member of the social network) to decide which future events to attend based on various criteria, such as cost, geographic location, future event availability, and the like.

Aspects of the invention also relate to the booking of travel to an event through the media platform. According to some embodiments, this may be accomplished by providing a connection to a booking engine/database of an organization issuing tickets or reservations for travel to the area of the event. The engine/database may be of the organization providing the travel itself, or an agent of the organization that provides the travel, such as a travel agency.

Aspects of the invention may also, additionally or alternatively, relate to booking of a ticket or reservation to attend an event through the media platform. Similarly to travel, this may be accomplished by providing a connection to a booking engine/database of an organization issuing tickets or reservations to the event. The engine/database may be of the organization hosting the event, or an agent of the organization that hosts the event.

Aspects of the invention may also relate to defining a travel itinerary for multiple travelers to a common destination, where at least some of the travelers are departing from different locations. Aspects of the invention may also relate to facilitating a voting, of sorts, among multiple travelers to decide on a common destination to which an itinerary is to be established. Additional aspects of the invention relate to providing travel itineraries for the multiple travelers that are optimized such that travel time, travel distance, geographical distance, or similar travel aspects are equalized, as much as may be possible, among the multiple travelers.

Embodiments of the invention may be implemented on one or more computing systems, such as a Global Distribution System (GDS), or a social networking system. The computing systems may be configured to allow travelers to book travel services, such as seats on a train or plane, a berth on a cruise ship, accommodations, a rental car, tickets for planned activities, or any other type of travel service.

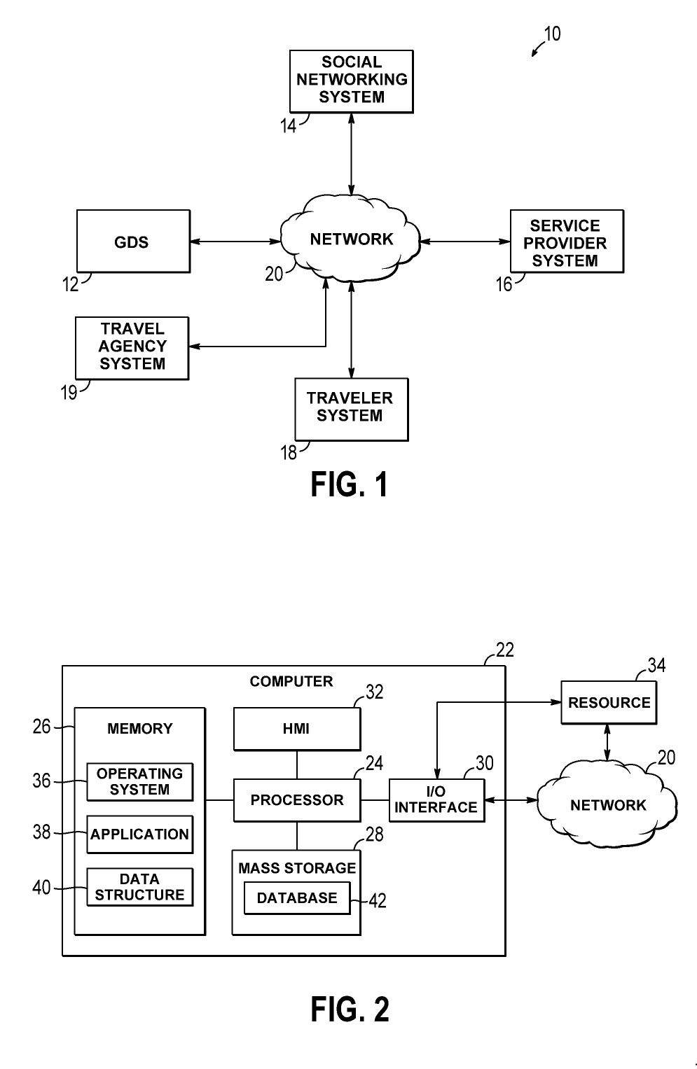

Referring now to FIG. 1, an operating environment 10 in accordance with an embodiment of the invention may include the Global Distribution System (GDS) 12, a social networking system 14, a service provider system 16, a traveler system 18, and a travel agency system 19. Each of the GDS 12, social networking system 14, service provider system 16, traveler system 18, and travel agency system 19 may communicate through a network 20. The network 20 may include one or more private or public networks (e.g., the Internet) that enable the exchange of data.

The GDS 12 may be configured to facilitate communication between the social networking system 14, the service provider system 16, the traveler system 18, and the travel agency system 19. The GDS 12 may thereby enable travelers to book reservations on the service provider system 16 via the GDS 12 and travel agency system 19. To this end, the GDS 12 may maintain links to a plurality of provider systems, such as the service provider system 16, via the network 20. These links may allow the GDS 12 to route reservation requests received from the social networking system 14 or travel agency system 19 to the service provider system 16. The GDS 12 may thereby enable the social networking system 14 or the travel agency system 19 to book services from multiple service providers. The GDS 12 may also facilitate communication between the social networking system 14 and the service provider system 16. For example, the GDS 12 may transmit information relating to travel services for dissemination to the social networking system 14. The GDS 12 may also receive information from the social networking system 14, such as updates to user accounts, requests for information relating to a travel service, or any other suitable information.

In response to the traveler booking a ticket, the GDS 12 may receive and store a Passenger Name Record (PNR). The PNR may be generated, at least in part, by the service provider system 16, and may comprise one or more reservation records that contain itinerary and traveler information associated with one or more booked reservations. The PNR may be stored in a PNR database (not shown) accessible to the GDS 12, and may include data defining an itinerary for a particular trip, passenger, or group of passengers. The defined itinerary may include travel services from multiple travel service providers. To facilitate locating the PNR in the PNR database, a record locator or other suitable identifier may be associated with the PNR.

The service provider system 16 may include a Computer Reservation System (CRS) for the respective travel service provider. The CRS may include one or more databases for storing and retrieving data related to reserving travel services, tracking service provider inventory, and issuing electronic tickets for the reserved travel services.

The traveler system 18 may comprise any suitable computing device that enables the traveler to access the social networking system 14. Exemplary computing devices may include, but are not limited to: a desktop computer, laptop computer, tablet computer, personal digital assistant, or smart phone. The social networking system 14 may provide a platform for the virtual social network. The virtual social network may comprise, for example, a plurality of user accounts that are selectively interconnected by virtual links. The virtual links may identify virtual relationships between the user accounts they link. Users having an account may create a user profile and a list of other users with whom they are connected. The virtual social network may thereby enable users to share information regarding their interests, activities, and background. This sharing of information may encourage users to form real-life connections with other users having similar interests. To provide access to users, the social networking system 14 may include one or more applications that allow the traveler system 18 to access the virtual social network, such as a web server application.

The travel agency system 19 may be configured to book travel through the GDS 12, and may be operated by a bricks-and-mortar travel agency, an on-line travel agency, a travel management company, or any other entity that sells or books travel services for travelers. To this end, the travel agency system 19 may include one or more applications that allow travelers to access the GDS 12. The travel agency system 19 may also include one or more web server applications that allow the traveler to book travel using a web browser or other application running on the traveler system 18.

Referring now to FIG. 2, the GDS 12, social networking system 14, service provider system 16, traveler system 18, and travel agency system 19 of operating environment 10 may be implemented on one or more computing devices or systems, such as exemplary computer 22. The computer 22 may include a processor 24, a memory 26, a mass storage memory device 28, an input/output (I/O) interface 30, and a Human Machine Interface (HMI) 32. The computer 22 may also be operatively coupled to one or more external resources 34 via the network 20 or I/O interface 30. External resources 34 may include, but are not limited to, computers, servers, databases, mass storage devices, peripheral devices, cloud based network services, or any other suitable computer resource that may be used by the computer 22.

The processor 24 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 26. Memory 26 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 28 may include data storage devices such as a hard drive, optical drive, tape drive, non-volatile solid state device, or any other device capable of storing information.

Processor 24 may operate under the control of an operating system 36 that resides in memory 26. The operating system 36 may manage computer resources so that computer program code embodied as one or more computer software applications, such as an application 38 residing in memory 26, may have instructions executed by the processor 24. In an alternative embodiment, the processor 24 may execute the application 38 directly, in which case the operating system 36 may be omitted. One or more data structures 40 may also reside in memory 26, and may be used by the processor 24, operating system 36, or application 38 to store or manipulate data.

The I/O interface 30 may provide a machine interface that operatively couples the processor 24 to other devices and systems, such as the network 20 or external resource 34. The application 38 may thereby work cooperatively with the network 20 or external resource 34 by communicating via the I/O interface 30 to provide the various features, functions, applications, processes, or modules comprising embodiments of the invention. The application 38 may also have program code that is executed by one or more external resources 34, or otherwise rely on functions or signals provided by other system or network components external to the computer 22. Indeed, given the nearly endless hardware and software configurations possible, persons having ordinary skill in the art will understand that embodiments of the invention may include applications that are located externally to the computer 22, distributed among multiple computers or other external resources, or provided by computing resources (hardware and software) that are provided as a service over the network 20, such as a cloud computing service.

The HMI 32 may be operatively coupled to the processor 24 of computer 22 in a known manner to allow a user to interact directly with the computer 22. The HMI 32 may include video or alphanumeric displays, a touch screen, a speaker, and any other suitable audio and visual indicators capable of providing data to the user. The HMI 32 may also include input devices and controls such as an alphanumeric keyboard, a pointing device, keypads, pushbuttons, control knobs, microphones, etc., capable of accepting commands or input from the user and transmitting the entered input to the processor 24.

A database 42 may reside on the mass storage memory device 28, and may be used to collect and organize data used by the various systems and modules described herein. The database 42 may include data and supporting data structures that store and organize the data. In particular, the database 42 may be arranged with any database organization or structure including, but not limited to, a relational database, a hierarchical database, a network database, or combinations thereof. A database management system may be provided by a computer software application executing as instructions on the processor 24. This database management system may be used to access the information or data stored in database records in response to a query. The query may be dynamically determined and executed by the operating system 36, other applications 38, or one or more modules. The database 42 may comprise, for example, a travel database, attraction database, or a travel booking database.

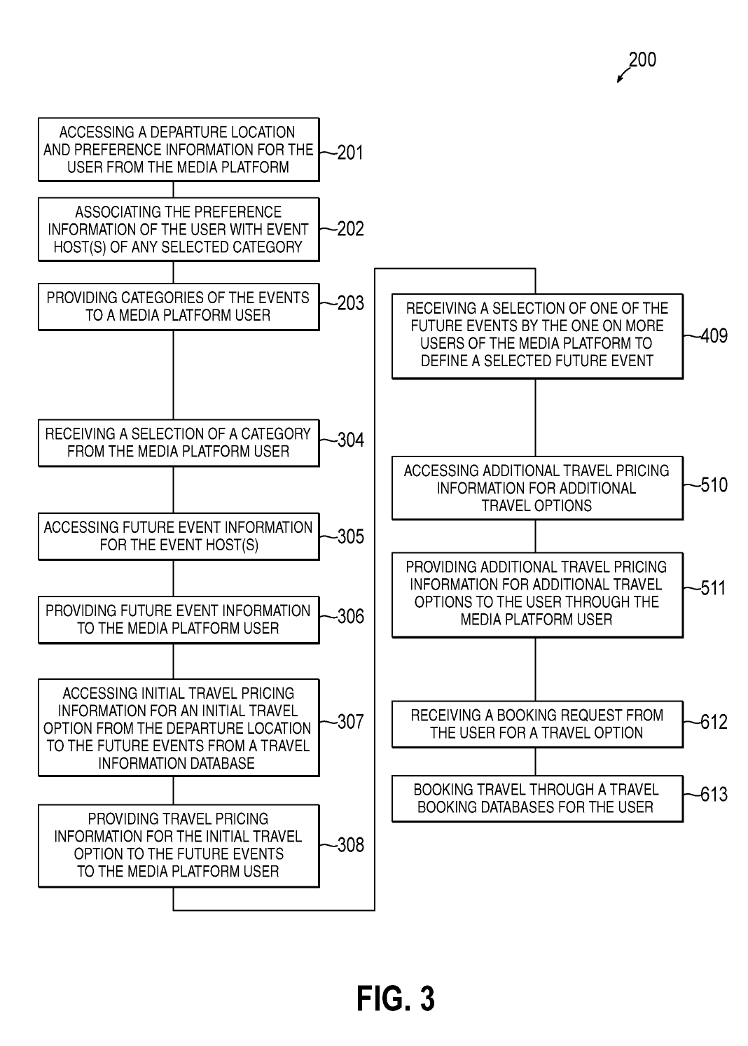

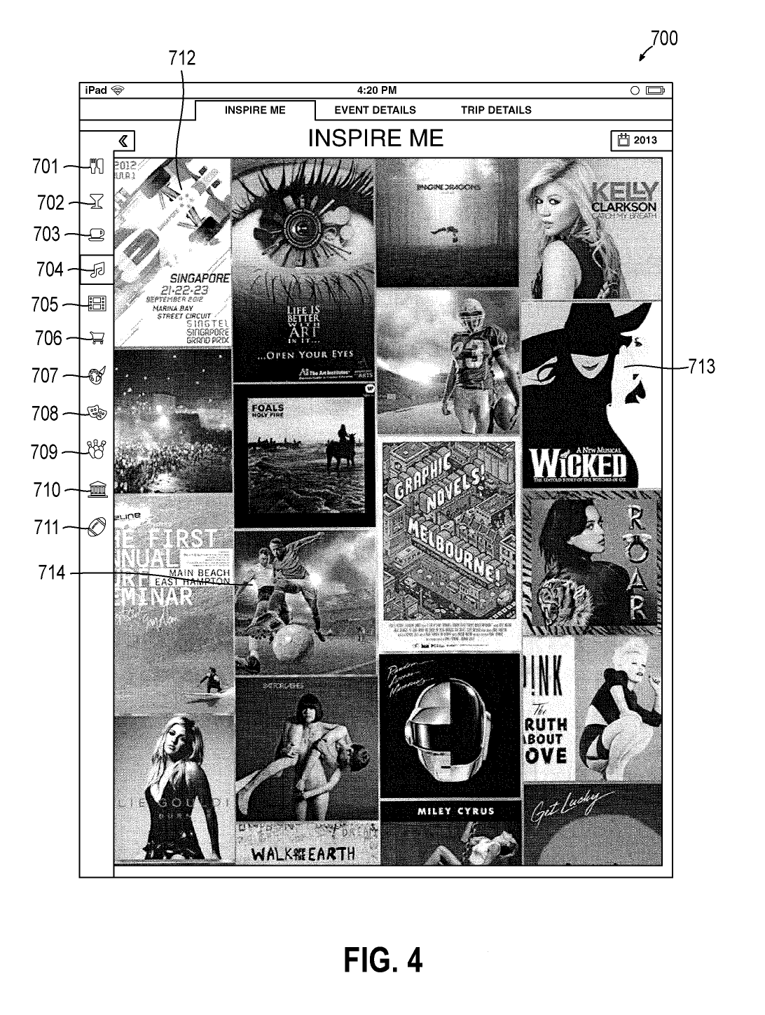

Referring now to FIG. 3, a flow chart 200 associated with various aspects of the invention is presented. Blocks 201 through 613 may represent a method that may be performed in association with the user interface 700 shown in FIG. 4. As reflected in block 201, a system may access a departure location and preference information for the user from a media platform, such as a virtual social network provided by the social networking system 14. The departure location may be ascertained through various ways, such as from a location specified by the user as their home town on the media platform, or by a present location of the user determined through a global positioning device or other system used to determine the present location of a user. Preference information may be obtained from the nature of things that the user shows preferences for within the media platform.

According to some embodiments, such as those associated with media platform FACEBOOK®, preference information may be derived from the types of products, music events, films, restaurants, bars, stores, plays, sporting teams, and sporting events, for example, which a user has indicated a “like” or similar indication that shows favoritism by the user. Preference information may, additionally or alternatively, be derived from the types of internet sites that the user visits and/or the types of products or services that a user may purchase through the internet. Other approaches may be used to identify preference information from the user, and embodiments of the invention are not limited in this respect.

The central portion of the user interface 700 shown in FIG. 4 may include graphical representations, or tiles 712-714 that may be associated with the preference information of the media platform user. In many cases, the graphical representations relate to events that are performed or hosted by event hosts associated with the preference information of the user. By way of example, a tile 712 showing the Singapore Grand Prix may be shown where preference information includes formula one racing. According to other examples, the musical Wicked is shown in a tile 703 when preference information reflects an interest in musicals of this nature, and an upcoming Real Madrid soccer match is reflected in a tile 714 where user preference information indicates an interest in a player for Real Madrid. Associating event hosts with preference information of a media platform is represented in the flow chart 200 of FIG. 4 in block 202 as well.

Various categories of events may be represented by icons along the left-hand side of the user interface 700, such as shown in FIG. 4 and as represented by block 203 of FIG. 3. These categories may include dining 701, night life 702, coffee shop events 703, music 704, film 705, shopping 706, arts 707, theatre 708, sporting events 709 (participation), museum events 710, and sporting events (spectator) 711, although other types and combinations of event categories are also contemplated. In the state represented in FIG. 4, the tiles 712-714 may reflect events associated user preference information and any of the categories events that are available.

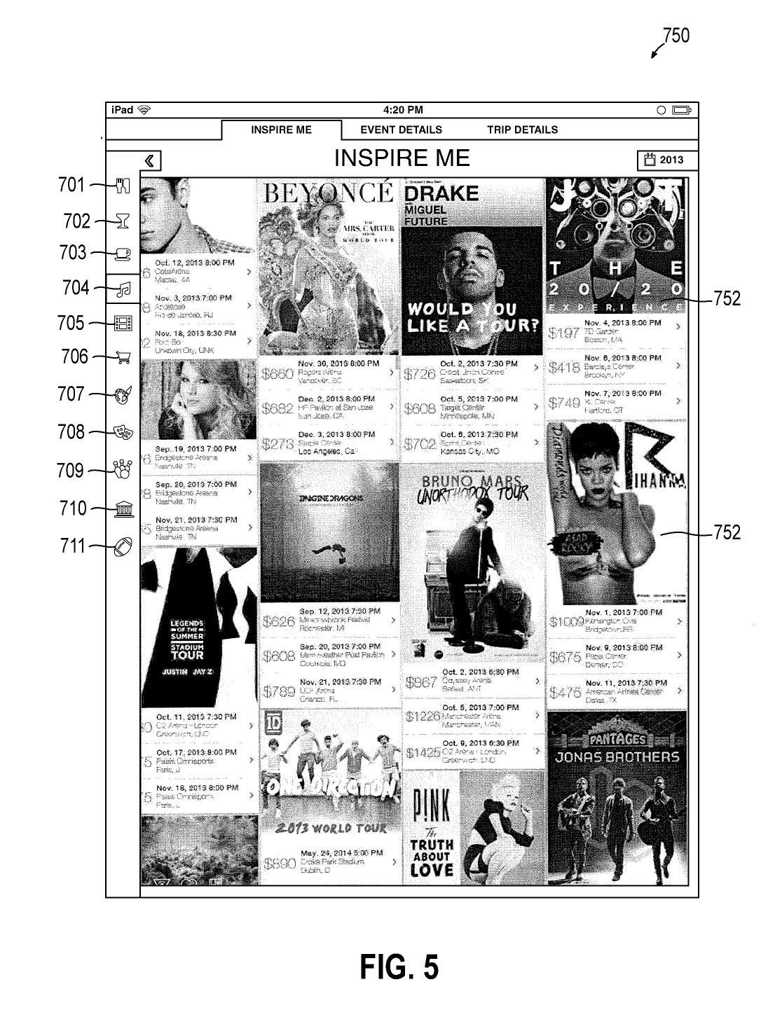

When a user selects a category or subset of categories available in the user interface 700, the tiles 712-714 that are shown may be limited to those associated with the selected category or subset of categories and the preference information of the user. By way of example, a user interface 750 shown in FIG. 5 reflects only tiles showing future events associated with music preferences of a user. This information may be displayed as a consequence of activating the music category icon 704 on the left hand side of the user interface 700. Limiting the tiles in this manner is also reflected in block 304 of the flow chart 200 in FIG. 3.

Referring now to FIG. 5, the user interface 750 displays information for future events that are associated with the tiles 712-714 are shown beneath the tiles 752 in the user interface 750 of FIG. 5. These future events, in the embodiment of FIG. 5, may include concerts associated with each of the musicians depicted in the tiles 752. In the illustrated embodiment, the next three concerts are shown for each musician. It is to be appreciated that other numbers of future events may be shown. Other criteria may also be specified for the future events that are depicted, such criteria associated with a particular time frame or geography in which the future events occur.

A price for travel to each of the future events of FIG. 5 may be shown adjacent to the time and location associated with the future event. This pricing information maybe for an initial travel option from the departure location of the user to the future events. The data used to generate the pricing information may be obtained from a travel database, such as a database provided by the GDS 12, social networking system 14, service provider system 16, or travel agency system 19. The pricing information may, by default, be associated with a departure from the departure location to the location of the future event on the day before the future event and return to the departure location the day after the future event. The pricing information may, according to some embodiments, include costs associated with a hotel stay, a rental car, and/or tickets or reservations to the future event. The price depicted for each future event may be the lowest price for travel to the event, although other criteria may also be used. According to some embodiments, the indicated price may reflect the lowest cost airfare alone, the lowest cost non-stop airfare, the lowest costs airfare selected from a flexible date range inclusive of the date of the future event, or some other set of criteria. The acts of accessing initial travel pricing information and providing this information to the user are reflected in blocks 307 and 308 of the flow chart 200 in FIG. 3.

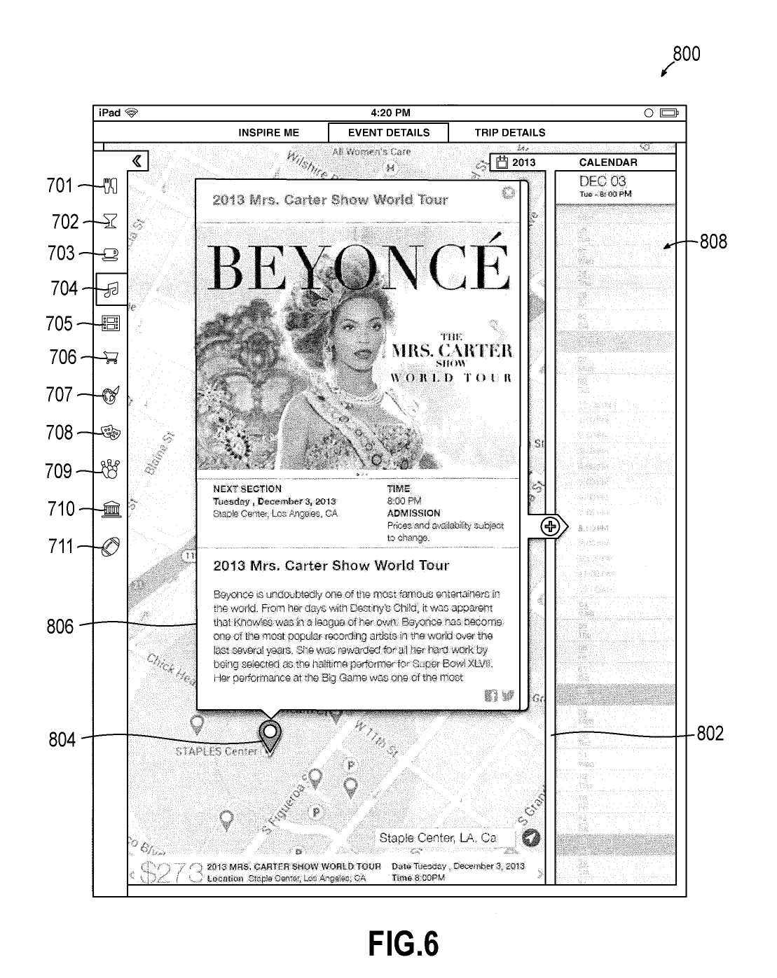

Referring now to FIG. 6, a user interface 800 is presented. When a user selects one of the future events, as reflected in block 409 of FIG. 3, the user interface 800 may show a map 802 of the area around the selected future event, including a pin 804 or other indicator for the location of the future event on the map, as reflected in the embodiment of FIG. 6. A pop out screen 806 may be activated when the pin 804 associated with the location of the future event is selected by the user. The pop out screen 806 may provide additional information about the event, such as specific show time, venue location, and/or a vignette about the future event. The map may also depict pins or other indicators associated with attractions or travel services that are near to the geographic location of the future event. Travel services may include hotels, airports, rental car locations, ticket offices, and the like. Pop out screens 806 may be activated when pins 804 associated with the attractions or travel services are selected by the user, providing additional information for the attraction or travel service. According to some embodiments, a user may indicate an attraction or travel service to be included in an event travel plan from a user interface like that of FIG. 6.

A calendar 808 is also depicted in the user interface 800 of FIG. 6. The calendar 808 may include the date of the selected future event and dates before and after the event. Although not shown, the calendar 808 may include other events or appointments of the user, as may be drawn from the media platform or other data sources of the user. The calendar 808 may, according to some embodiments, be used solely to display information to the user. According to other embodiments, the user may input preferred travel dates or a preferred range of dates by indicating such on the calendar 808. In such embodiments, the indicated dates or range of dates may be used in searching for available travel options and prices associated with such travel options.

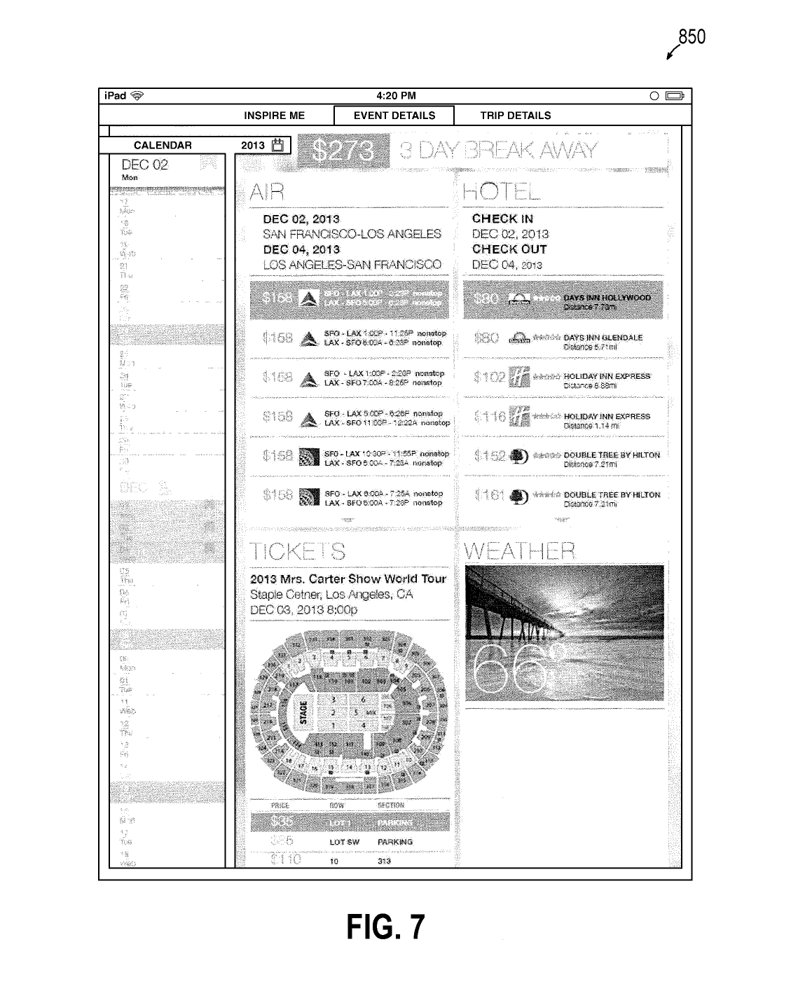

The user interface 850 depicted in FIG. 7 shows information associated with the selected future event, including flight options, seating options at the venue of the future event, hotel options near the venue of the future event, and weather information at the time and location of the future event. Other embodiments may show different types or combinations of information, and may present such information in a different manner than that shown in FIG. 7. Embodiments of the invention are therefore not limited in this respect. From an interface like that of FIG. 7, the user may select specific flights, hotel, seats, and the like for the future events. Blocks 510 and 511 of FIG. 3 reflect the acts associated with the user interface shown in FIG. 7, as one of skill in the art may appreciate.

A travel itinerary may be generated from the selections of the user made through user interfaces of the media platform, such as those depicted in FIGS. 4-7. Such an itinerary may be used to book reservations or tickets for flights, hotels, rental cars, events, or any other items selected by the user for inclusion on the itinerary.

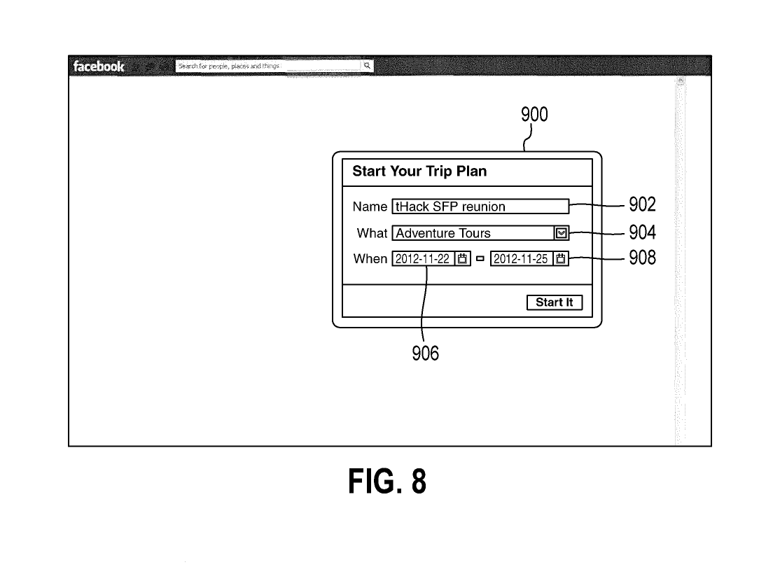

Referring now to FIG. 8, an exemplary initial screen 900 that may be displayed by an application for planning group travel, as may be embodied in a social media platform, such as FACEBOOK®. The initial screen may include a field 902 where a title of an event or trip may be entered by the user. As illustrated, this field 902 may allow the user to enter free form text to name the event or trip as they wish. A theme field 904 may also be included, and may be associated with a drop down menu where a user may select from several pre-defined travel themes for the event or trip. By way of non-limiting example, themes may include adventure travel, skiing travel, sports event travel, beach travel, or historical sight-seeing travel among other topics. The initial user screen may further include a departure date field 906 and a return date field 908 for the event or trip.

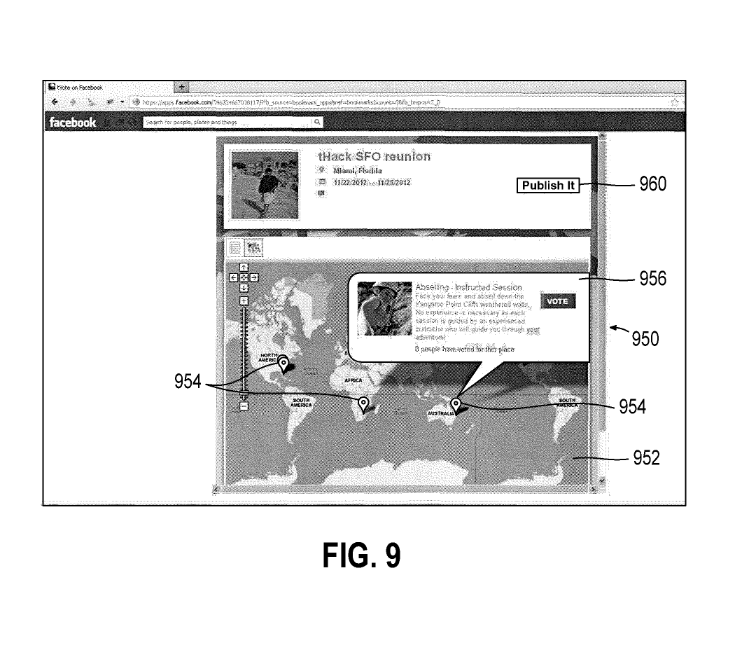

Referring now to FIG. 9, a subsequent screen 950 that may be displayed by the application for planning group travel is presented according to one embodiment. The screen 950 may include a map 952 on which pins 954 indicate potential travel destinations that are associated with the theme selected by the user in a screen, such as the screen 900 depicted in FIG. 8. A pop out screen 956 or similar feature may provide additional information associated with each destination selected.

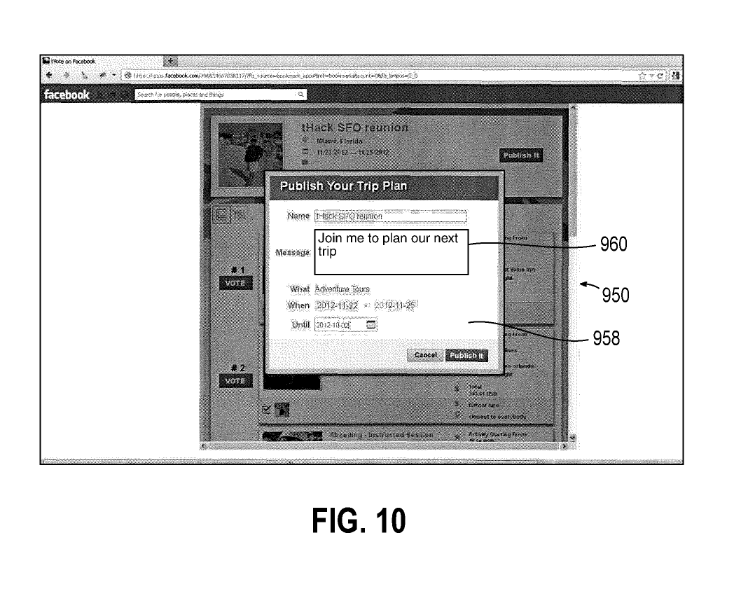

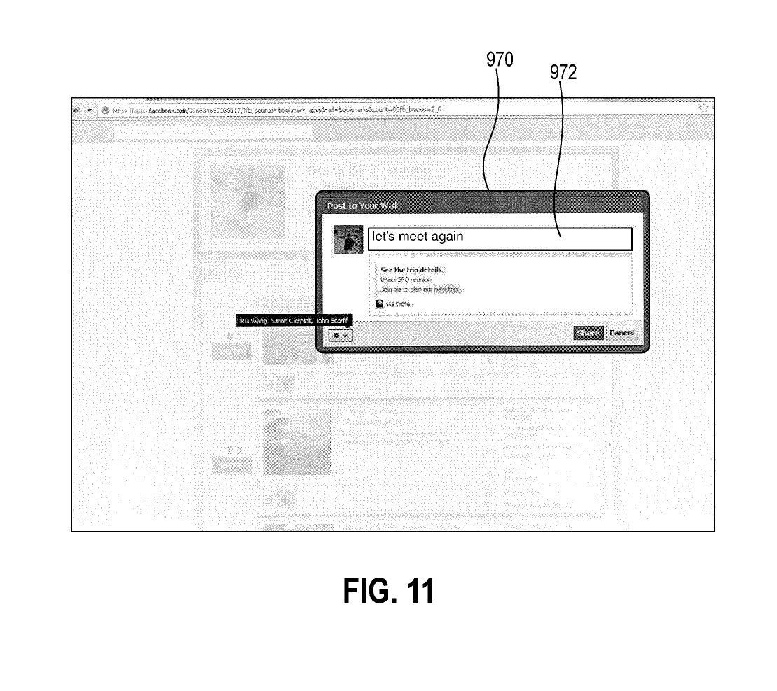

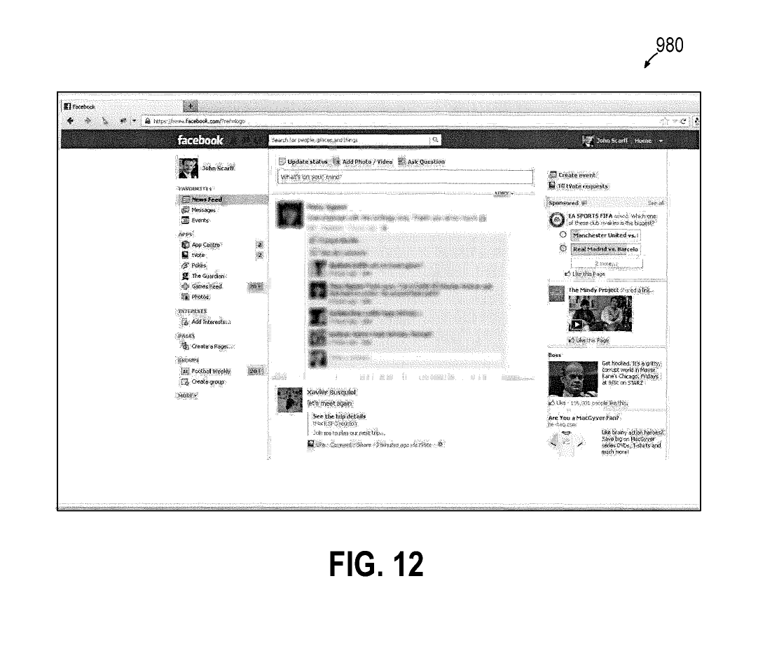

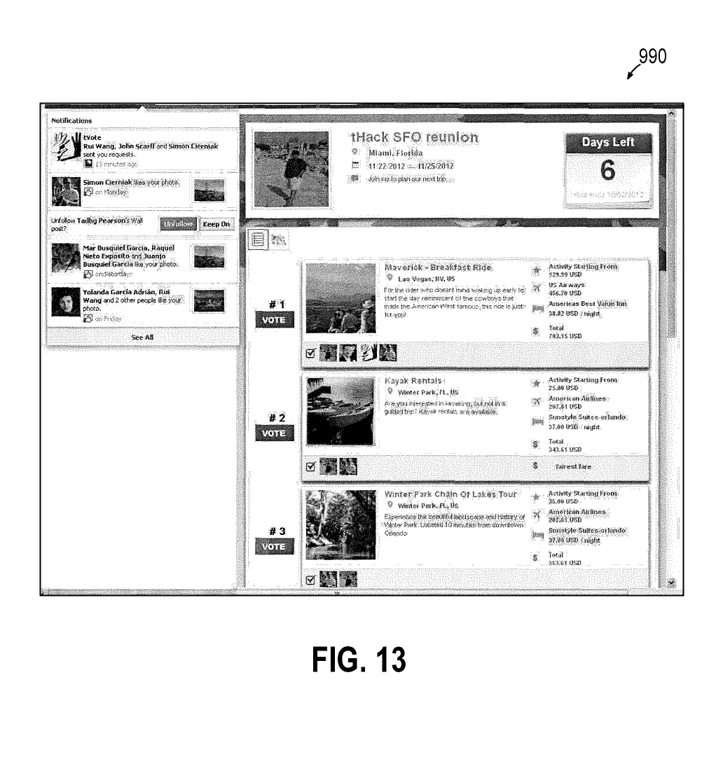

FIG. 10 shows a pop out screen 958 that is activated when a “publish it” button 960 in the screen 950 of FIG. 9 is activated. The pop out screen 958, or other similar feature, allows the user to invite other users of the media platform on which the software operates to join the initial user for the event or trip. As shown, the pop out screen 958 includes a field 960 where the initial user may include a personalized message for other invited users. It is to be appreciated that the initial user may extend an invitation to all other users of the media platform with which the initial user is associated, or to some subset of these users as reflected by the invitee names in the lower left hand corner of FIG. 11. FIG. 11 depicts a pop out screen 970 that provides a field 972 for entering a message to post to a user profile of the social media platform. FIG. 12 is a screen shot depicting the user profile 980 that may be displayed to a viewer accessing the social media platform. FIG. 13 depicts a screenshot of an exemplary trip 990 posted to the user profile.

Use of a media platform may facilitate communication and decision making among multiple potential travelers about the event or trip. Media platform private messaging, wall posting, and other types of communications available through social media platforms may facilitate threads of communication on topics relevant to a trip. Additionally or alternatively, voting or preference indications that may be issued by a user in a media platform, such as a “like” or a “dislike” may be tallied or used in a calculation to determine a travel destination for the multiple travelers.

The travel database may be accessed for travel information associated with travel for each of the multiple users of the media platform invented to participate in the event or trip. The travel information may include flight availability and/or pricing, hotel availability and/or pricing, and the like. According to some embodiments, destinations may be suggested by the software program through the media platform that optimize or balance various factors for the multiple travelers. These factors may include, but are not limited to travel price, travel time, travel distance, and geographic distance to the destination.

The subject matter shown in FIGS. 1-7 and described in the corresponding written description herein was disclosed on Sep. 19, 2013 a part of a hack for the Tnooz THack event in San Francisco. The event-based, travel inspiration app provides a dynamic event builder and planner application. The app uses social channels, such as Facebook, to identify and connect lovers of culture—music, film, food, events, and more—to the experiences in which they are most interested and enables them to build travel packages around key dates and cities where those interests are taking place.

The subject matter shown in FIGS. 8-13 and described in the corresponding written description herein was disclosed on Sep. 20, 2012 a part of a hack for the Tnooz THack event in San Francisco. TVote allows a social media user, e.g., a Facebook user, to share a list of destinations based on a theme, such as adventure tours, scuba diving, skiing, etc., with a selected group of friends. As each member views the list of possible destinations, the app automatically calculates several flight options from the user's location to each destination in the list, and selects the same hotel at the destination for all of the friends. Each friend can then vote on their preferred destination(s), and, as the votes are tallied, the app automatically calculates the leading vote-getter. The app also has the capability to select the Fairest Fare (least deviation from the mean) as well as the destination which is most central, based on the points of origin for each interested friend. When the voting period ends, all interested friends receive a notification to accept the winning destination. Once accepted, the users can directly book the trip through the app or can pass it on to travel agents who can then start to get prices for group bookings. The social media-driven application enables group bookings to be organized and booked using a voting system from participants.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

In certain alternative embodiments, the functions, acts, and/or operations specified in the flowcharts, sequence diagrams, and/or block diagrams may be re-ordered, processed serially, and/or processed concurrently consistent with embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A method of building a travel plan for an event, the method comprising:
accessing a departure location and preference information associated with one or more users of a media platform;
associating the preference information of the one or more users with one or more event hosts;
accessing future event information for at least one of the one or more event hosts;
providing the future event information to the one or more users of the media platform;
accessing initial travel pricing information for an initial travel option by the one or more users from the departure location to at least one of the future events from one or more travel databases; and
providing the initial travel pricing information for at least the initial travel option to the future events to the one or more users of the media platform.

2. The method of claim 1 further comprising:
receiving a selection of one of the future events by the one or more users of the media platform to define a selected future event;
accessing additional travel pricing information, different than the initial travel pricing information, for additional travel options by the one or more users from the departure location to the selected future event from the one or more travel databases; and
providing the additional travel pricing information to the one or more users of the media platform.

3. The method of claim 2 further comprising:
receiving a first booking request from a user for at least one travel option selected from a group of travel options consisting of the initial travel option to the selected future event and the additional travel options to the selected future event; and
booking travel through one or more travel booking databases for the one or more users according to the at least one travel option selected from the group of travel options consisting of the initial travel option and the additional travel options to the selected future event.

4. The method of claim 2 further comprising:
accessing one or more attraction databases to identify attractions geographically near the selected future event as identified attractions; and
providing attraction information associated with the identified attractions to the one or more users of the media platform.

5. The method of claim 4 further comprising:
receiving a second booking request from a user for one or more of the identified attractions; and
booking attendance to the one or more of the identified attractions.

6. The method of any of claim 4 further comprising:
plotting a first geographic location of the selected future event on an event map; and
plotting a second geographic location of the identified attractions on the event map.

7. The method of claim 1 further comprising:
providing a plurality of categories to the one or more users of the media platform; and
receiving a selection of one of the plurality of categories as a selected category,
wherein the future event information provided to the one or more users is associated with the selected category.

8. The method of claim 7 wherein the plurality of categories includes at least one category selected from a group consisting of a dining category, a nightlife category, a coffee shop category, a music category, a film category, an arts category, a theatre category, a sports participation category, and a sports for spectators category.

9. The method of claim 1 wherein the future events and future event information are associated with events that are transient in at least one of starting time and geographic location.

10. An apparatus for building a travel plan for an event, the apparatus comprising:
a processor; and
a memory including program code that, when executed by the processor, causes the apparatus to:
access a departure location and preference information associated with one or more users of a media platform;
associate the preference information of the one or more users with one or more event hosts;
access future event information for at least one of the one or more event hosts;
provide the future event information for future events to the one or more users of the media platform;
access initial travel pricing information for an initial travel option by the one or more users from the departure location to at least one of the future events from one or more travel databases; and
provide the initial travel pricing information for at least the initial travel option to the future events to the one or more users of the media platform.

11. (canceled)

12. A method of defining a travel itinerary for each of a plurality of users of a social media platform for travel to a common destination, the method comprising:
presenting, by a computer, a plurality of travel themes across the media platform to at least one initial user of the media platform;
receiving, by the computer, a travel theme selection from the at least one initial user of the media platform;
presenting, by the computer, a plurality of travel destinations to the plurality of users of the media platform, wherein the plurality of users are selected by the at least one initial user of the media platform;
accessing, by the computer, a departure location for each of the plurality of users from the social media platform, wherein the departure location of at least one of the plurality of users is different from another of the plurality of users;
accessing, by the computer and from a travel database, the plurality of travel destinations associated with the travel theme selection;
accessing, by the computer from the travel database, travel information from the departure location and to at least one of the plurality of travel destinations for each of the plurality of users, wherein the travel information includes travel availability information and travel pricing information;
presenting, by the computer and through the media platform, the travel information to the plurality of users;
receiving, by the computer and through the media platform, preference information from the plurality of users; and
calculating, by the computer, a selected destination based on preference information associated with the plurality of travel destinations.

13. The method of claim 12, further comprising:
booking, by the computer and through a travel booking database, travel for at least one of the plurality of users.

14. The method of claim 12, wherein presenting the travel information to the plurality of users by the computer and through the media platform includes presenting travel information that provides a lowest deviation from a mean of travel pricing for each of the plurality of users.

15. The method of claim 12, wherein presenting the travel information to the plurality of users by the computer and through the media platform includes presenting travel information that provides a lowest deviation from a mean of travel duration for each of the plurality of users.

16-17. (canceled)
